(19) United States
(12) Patent Application Publication
(10) Pub. No.: US 2006/0031320 A1
(43) Pub. Date: Feb. 9, 2006

(54) Electronic mail distribution system for permitting the sender of electronic mail to control the redistribution of sent electronic mail messages

(75) Inventors: Lane Thomas Holloway, Pflugerville, TX (US); Walid M. Kobrosly, Round Rock, TX (US); Nadeem Malik, Austin, TX (US); Avijit Saha, Somers, NY (US)

Correspondence Address: Mark E. McBurney;International Business Machines Corporation, Intellectual Property Law Department, Internal Zip, 11400 Burnet Road, Austin, TX, 78758, US

(73) Assignee: International Business Machines Corporation, Armonk, NY (US)

(21) Appl. No.: 10/870,537

(22) Filed: Jun. 17, 2004

(51) Int. Cl. G06F 15/16

(52) U.S. Cl. 709/206

(57) ABSTRACT

A system that will enable the sender of the E-mail to control the redistribution of the message tasks that are to be redistributed by the receiver of the E-mail. More particularly, the present invention comprises enabling the sender of E-mail to specify conditions for the redistribution of an E-mail message sent to a receiving display terminal in combination with an implementation enabling this sender to track the redistribution of the sent E-mail message and apparatus enabling the sender to change the redistribution of the E-mail message. According to the invention, initially, there is an implementation enabling a user at the terminal receiving the sent E-mail message to redistribute the sent E-mail message subject to the conditions specified by the sender. The sent E-mail message specifies tasks divided out of the sent E-mail message to be assigned, respectively, to subsequent receivers of the redistribution messages by such messages.

### TECHNICAL FIELD

The present invention relates to computer managed communication networks such as the World Wide Web (Web), electronic mail (E-mail) messages transmitted over such networks and particularly to controlling the redistribution of such E-mail messages to thereby also control tasks assigned in such redistributed messages.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents. The Web or Internet, which had quietly existed for over a generation as a loose academic and government data distribution facility, reached “critical mass” and commenced a period of phenomenal expansion. With this expansion, businesses and consumers have direct access to all matter of documents and media through the Web. Also, as a result of the rapid expansion of the Web, E-mail, which has been distributed for over 25 years over smaller private and specific purpose networks, has moved into distribution over the Web because of the vast distribution channels that are available.

As a result of this expansion, extraordinary worldwide communication channels and resources have become available to businesses, and this has commenced an era that should forever change how business processes are conducted.

The era is marked by what may be referred to as “virtual enterprises”, i.e. businesses relying on workflow distribution processes to conduct their business. Conventionally, business processes have been carried out completely within the limits of a company. The processes begin and are completed within the company boundaries. External requests came into the company as faxes, phone calls, postal mail and even electronic mail. These requests are then forwarded to appropriate personnel who initiate the internal process to handle the request. When the appropriate business processes are completed, the final actions are taken, such as shipping the goods out of the company, followed by appropriate phone calls, mail or faxes from the shipping company. Status inquiries were handled by internal people.

However, globalization has driven businesses away from these more leisurely methods of doing business. Now, with the Internet and like wide area networks, the business processes of customers and suppliers routinely interact with a minimum of human intervention. These interactions may range from simple inquiries to complex interactions between companies to situations where organizational units of different companies are related by sharing data and business processes so that they operate like independent or virtual enterprises. The companies no longer have to use phone calls or mail orders to do business with each other. Through the use of networks like the Internet, business processes of different companies handle each others' requests with little manual intervention; no interaction is required to have one business process talk to another business process of a different company.

In the face of such challenges in the control of distributed tasks assigned via electronic mail, it is very desirable for a person responsible for the distribution and performance of tasks to retain at least some capability of monitoring the performance of the redistributed tasks, and to have some control over such performance of the message tasks.

### SUMMARY OF THE PRESENT INVENTION

The present invention is directed to a system that will enable the sender of the E-mail to control the redistribution of the message tasks that are to be redistributed by the receiver of the E-mail. More particularly, the present invention comprises means enabling the sender of E-mail to specify conditions for the redistribution of an E-mail message sent to a receiving display terminal in combination with means enabling this sender to track the redistribution of the sent E-mail message, and means enabling the sender to change said redistribution of the E-mail message. According to the invention, initially, there are means enabling a user at the terminal receiving the sent E-mail message to redistribute the sent E-mail message subject to the conditions specified by the sender. The sent E-mail message specifies tasks divided out of the sent E-mail message to be assigned respectively to subsequent receivers of the redistribution messages.

The system may further include delegation means at the terminal receiving said sent E-mail message enabling the user to delegate the tasks among said subsequent receivers of the redistribution messages. If the receiving terminal has such delegation means, then the sender may be provided with means enabling the sender to send said E-mail for redistribution directly to such delegation means.

Among the control functions that the sender may exercise is the cancellation of any or all redistribution messages and, consequently, the termination of such redistributed tasks. Of course, the sender may choose to only modify such distributed messages and tasks. The sender is also enabled to preclude any subsequent redistribution of E-mail or the assigned messages and tasks therein.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized view of an E-mail distribution system over an illustrative Internet or Web portion on which the E-mail redistribution control by the sender may be carried out;

FIG. 2 is a block diagram of a data processing system including a central processing unit and network connections via a communications adapter that is capable of implementing the sending and receiving display computer terminals for E-mail, as well as implementing any of the Web servers;

FIG. 3 is an illustrative generalized view of a portion of a sending terminal display screen showing the information available to a management sender who has sent E-mail requesting the tasks to be redistributed;

FIG. 4 is an illustrative display screen of a receiving user at a terminal that has received the E-mail of FIG. 3 and has redistributed one of the message tasks to another person for implementation;

FIG. 5 is an illustrative display screen of another receiving user at another terminal that has received the E-mail of FIG. 3 and has redistributed one of the message tasks to another person for implementation;

FIG. 6 is the interactive display screen of the sender of FIG. 3 using the displayed redistribution tracking information available to the sender from which he may interactively control the redistribution;

FIG. 7 is an illustrative flowchart describing the setting up of the functions to send E-mail functions for redistribution and to control such redistributed functions by the sender; and

FIG. 8 is a flowchart of an illustrative run of the program set up according to FIG. 7.

### DETAILED DESCRIPTION OF THE PREFERRED EMBODIMENT

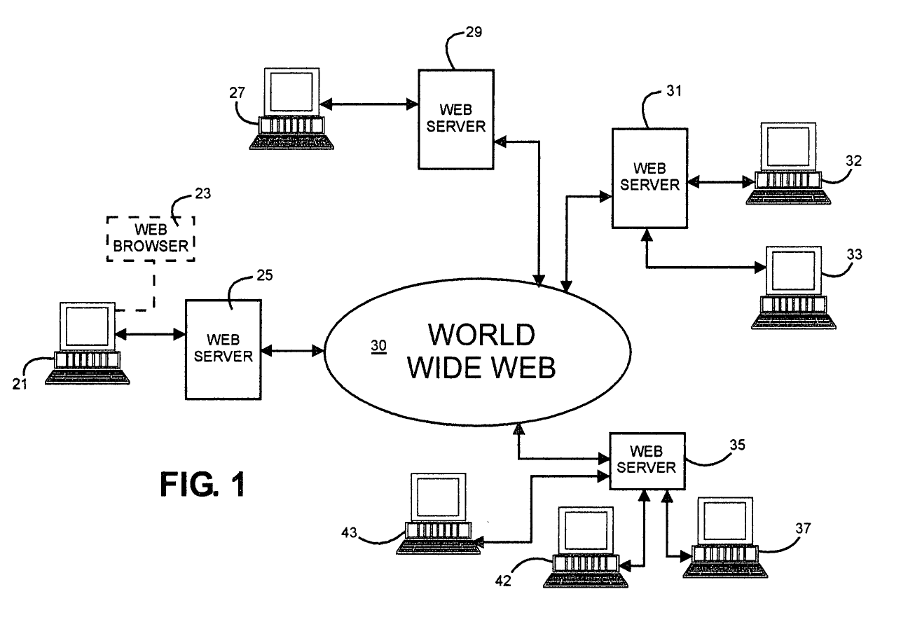

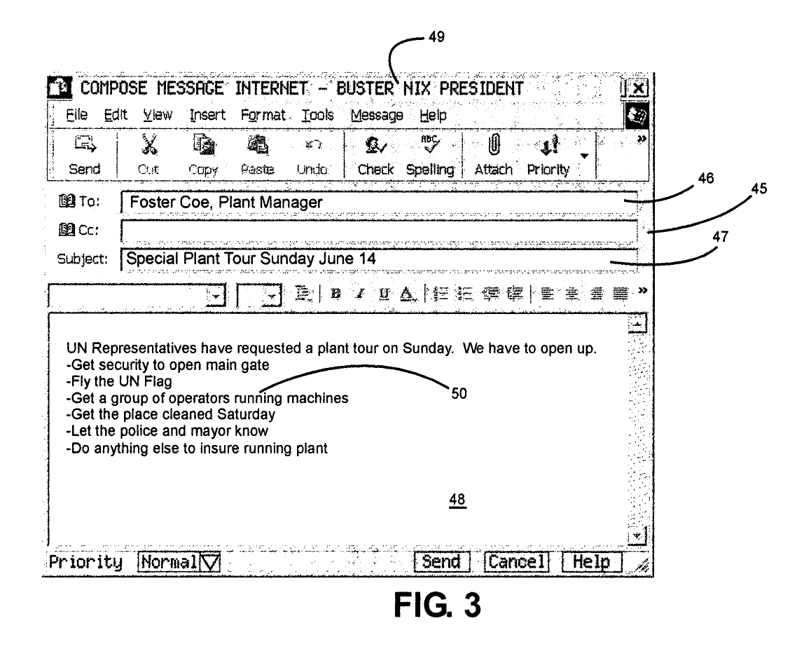

Referring to FIG. 1, there is provided a generalized electronic mail distribution system over a network, such as the Internet, showing the elements of the monitored and controlled E-mail task redistribution system of the present invention. In the following description, it will be understood that the described elements will be controlled and initiated by a sender of E-mail at display terminal 21 sending an E-mail message to receiving display terminal 27 for redistribution, as will hereinafter be described in greater detail with respect to the display screen sequence of FIGS. 3 through 6.

Before going further into the details of specific embodiments, it will be helpful to understand from a more general perspective the various elements and methods that may be related to the present invention. Since the major aspect of the present invention is directed to Web electronic mail transmitted over global networks, such as the Web or Internet, an understanding of networks and their operating principles would be helpful. We will not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999. Any data communication system that interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers.

Web documents including E-mail may be implemented in HyperText Markup Language (HTML) language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition, particularly in Chapter 19, pp. 419-454, on the Netscape Navigator; in Chapter 20, pp. 455-494, on the Microsoft Internet Explorer; and in Chapter 21, pp. 495-512, covering Lynx, Opera and other browsers.

Returning now to the details of FIG. 1, sending display terminal 21 illustrates an E-mail sending terminal having a display screen on which sent E-mail is created, and the redistribution of E-mail message tasks may be monitored and controlled, as will hereinafter be described in detail with respect to FIGS. 3 through 6. Terminal 21 is connected into the Internet or Web 30 through Web server 25. In the present illustration, the management E-mail basic or initial message for message task redistribution is sent to receiving display terminal 27 via Web server 29, which, in turn, redistributes the message tasks via Web 30 to send individual message tasks respectively to receiving terminals 32 and 33 via Web server 31, and to receiving terminals 37, 42 and 43 via Web server 35. All this redistribution is monitored and controlled by the management sender at sending terminal 21 through Web browser 23, as will hereinafter be described in greater detail with respect to FIGS. 3 through 6.

Now, with respect to the sequence of FIGS. 3 through 6, there will be described a simple illustration of the practice of the present invention wherein the sender of the E-mail message retains the capability to monitor and control the redistribution into subsequent E-mail task assigning messages. In FIG. 3, the interactive display screen 45 of the initiating sender 49 is shown. In the example, as it turns out, a United Nations delegation has requested a special plant visit causing Mr. Nix, the president 49 to instruct his plant manager by the E-mail shown in the list 50 of tasks that Nix has entered into the message area 48. This E-mail is then addressed 46, sent to Coe, the manager, with reference to the plant visit 47.

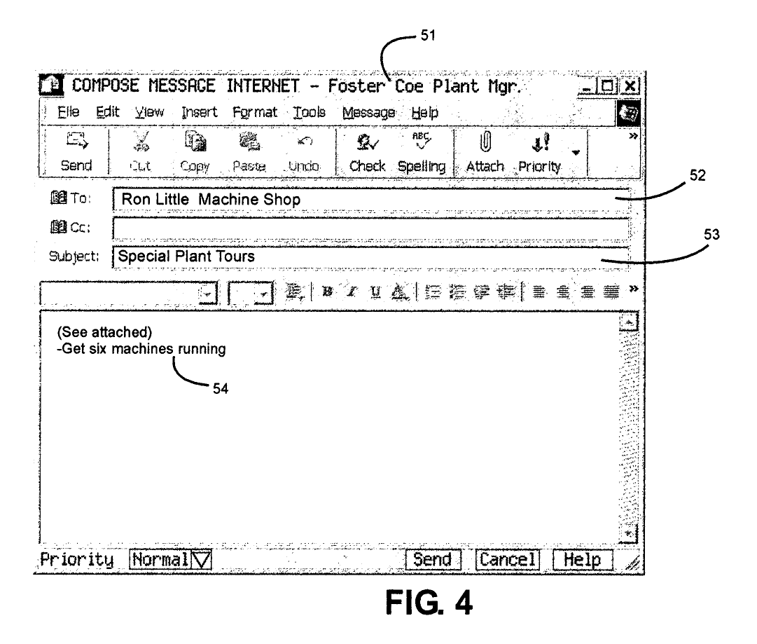

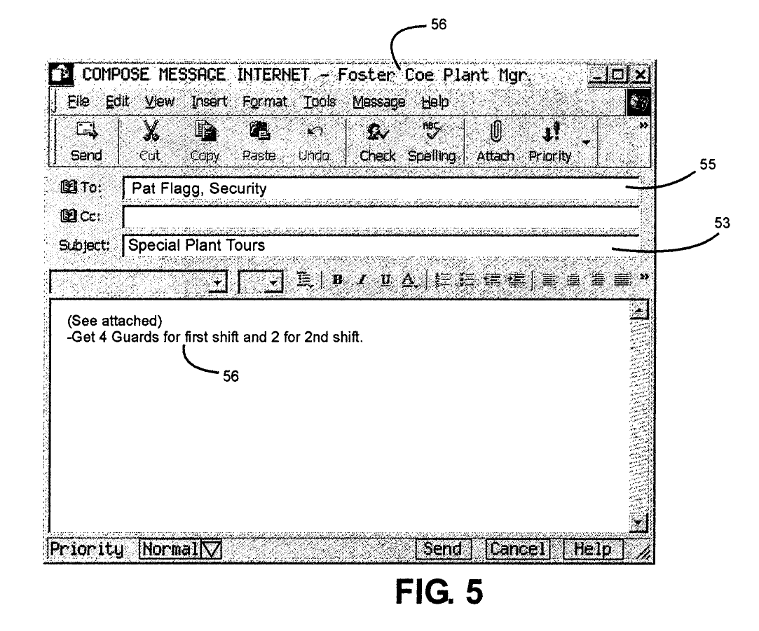

The plant manager, Coe, then proceeds to redistribute message tasks, e.g. task 54 in E-mail message 51, to a Ron Little 52, referring to tour 53 and requesting that Little keep six machines running, FIG. 4. Coe also sends a similar E-mail task assigning message 56, FIG. 5, to Pat Flagg, his security manager 55, requesting four extra guards. Several additional E-mail messages, not shown, are redistributed by Coe assigning tasks consistent with the agenda 50 set forth by Nix, the sender of E-mail 48, FIG. 3.

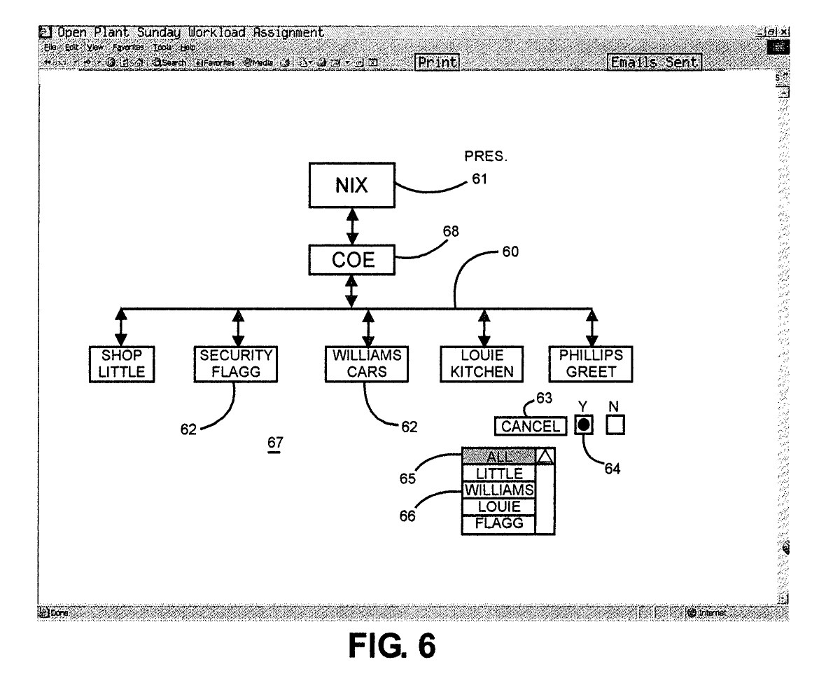

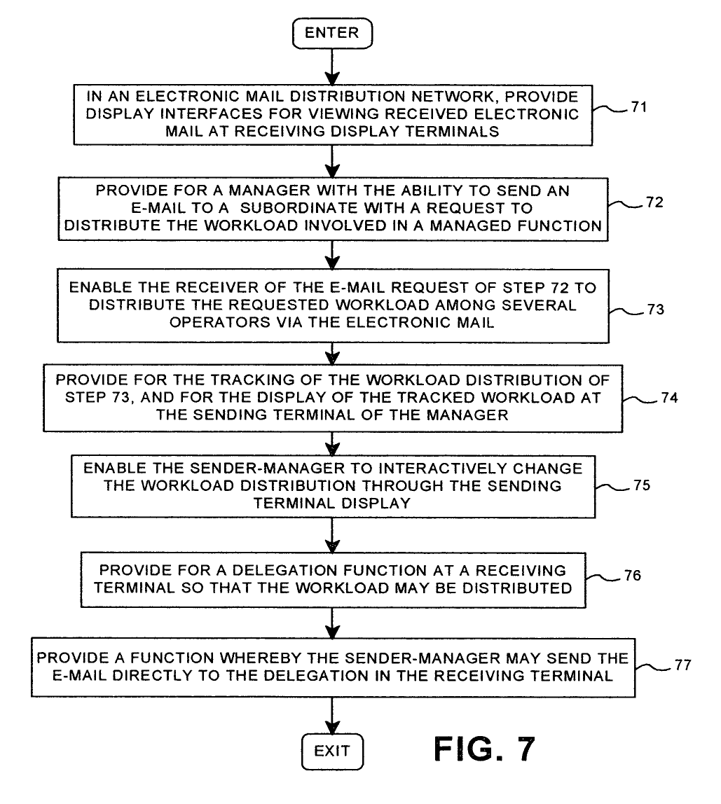

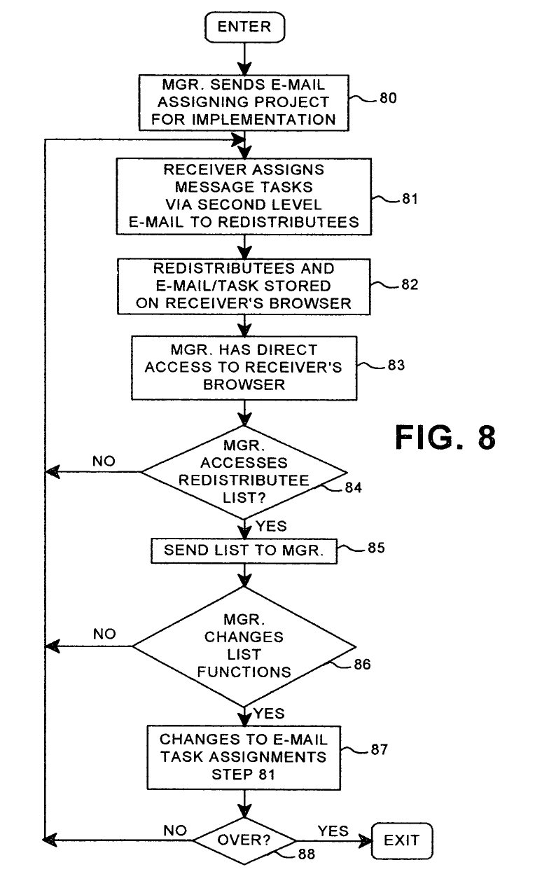

Through the programs of the present invention, subsequently described with respect to FIGS. 7 and 8, the sender of the initial E-mail, President Nix 61, FIG. 6, can track the redistribution 60 of the tasks 62 by the manager, Coe, 68 through E-mail tasks assigned to a variety of personnel for performance. This can all be controlled by the sender Nix. This sender control screen 67 is maintained at the sender terminal 21 supported through Web browser 23, FIG. 1. Through the interactive control display screen 67, FIG. 6, the sender chooses to cancel 63 by selecting “Y” 64 for any of the redistributed tasks in scroll menu 66 or all of the tasks 65. While this illustrative example covers the cancellation of redistributed tasks, it will be recognized that a similar process could be used for the modification of tasks.

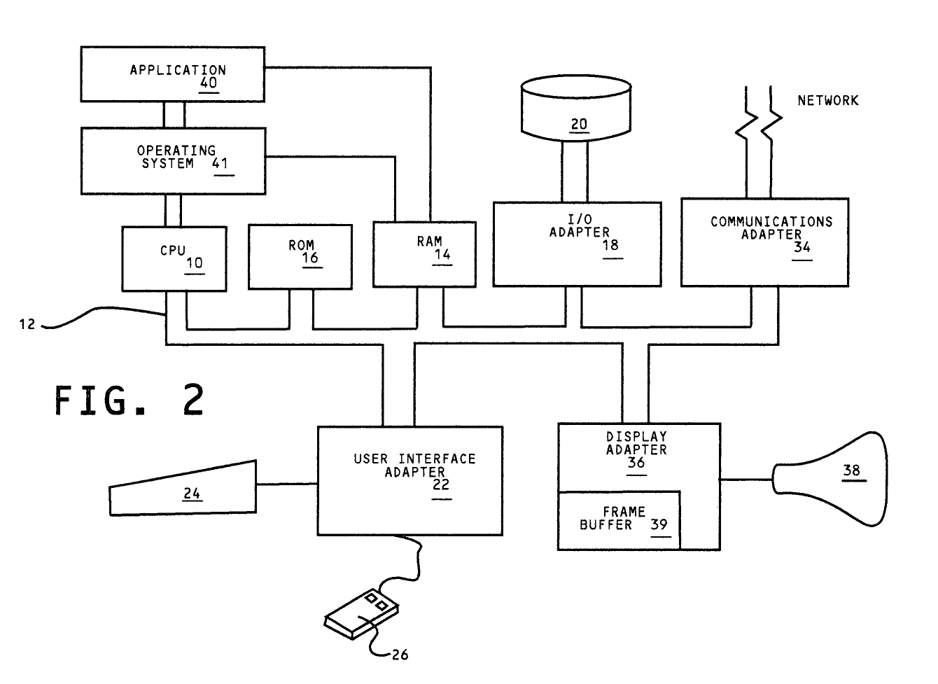

Before proceeding with a description of the computer programming used in the implementation of this invention, reference should be made to FIG. 2 that shows a typical data processing terminal that may function as a sending display terminal 21, any of the receiving display terminals 27, 32, 33, 37, 42 or 43 (FIG. 1) or Web servers 25, 29, 31, 35 and 51 (FIG. 1). The data processing central processing unit (CPU) 10, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 2. Operating system 41 may be one of the commercially available operating systems such as the AIX 6000™ operating system available from IBM; Microsoft's Windows XP™ or Windows NT™, as well as UNIX and AIX operating systems. Application programs 40, controlled by the system, are moved into and out of the main memory, random access memory (RAM) 14. These programs include the programs of the present invention for enabling the E-mail sender to track the redistribution of E-mail message tasks.

A read only memory (ROM) 16 is connected to CPU 10 via bus 12 and includes the basic input/output system (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with an outside network enabling the data processing system to communicate as respectively described above through the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively receive or control E-mail messages. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Now, with respect to FIG. 7 there will be described the programming functions that should be set up in order to practice this invention. In an electronic mail distribution network, such as the Internet, a conventional E-mail receiving system is set up with receiving display terminals for receiving and viewing E-mail, step 71. A project manager at a sending terminal is provided with the ability to send an E-mail to a subordinate with a request that the subordinate distribute the workload involved in a particular managed function, step 72. The subordinate receiving the E-mail request of step 72 is enabled to distribute the requested workload among several operators via the electronic mail, step 73. There is then provided the tracking of the workload distribution of step 73 and for the display of the tracked workload at the sending terminal of the manager, step 74. The sender-manager is then enabled to interactively change the workload distribution through the sending terminal display, step 75. A delegation function is provided at the receiving terminal so that the workload may be distributed therethrough, step 76. Lastly, there is provided an implementation whereby the sender-manager may send the E-mail directly to the delegation function in the receiving terminal, step 77.

Now, with reference to the flowchart of FIG. 8 a simplified illustrative run of the process set up in FIG. 7 will be described. Initially, a higher management person sends an E-mail to a project manager assigning a project for implementation, i.e. distribution of tasks, 80. The receiver assigns E-mail message tasks via second level E-mail to several redistributees for performance, step 81. The listings of the E-mail assigned tasks and their respective redistributees are stored on the receiver's browser, step 82. The initial manager-sender is given direct access to the stored material on the receiver-manager's Web browser, step 83. In this situation, a determination is made as to whether the original-sender manager wishes to access the stored redistributees list, step 84. If Yes, the list is sent to the original sender-manager, step 85. Then a determination is made, step 86, as to whether the original manager changes the stored list of functions. If Yes, step 87, the changes are made to the E-mail task list of step 81. If either the determination in step 84 or in step 86 is No, then the process is branched back to step 81. At this point, a determination may conveniently be made as to whether the session is over, step 88. If Yes, it is exited. If No, then the process is branched back to step 81.

It should be noted that the programs covered by the present invention may be stored outside of the present computer systems until they are required. The program instructions may be stored in another readable medium, e.g. in disk drives associated with the receiving terminals or the hub servers. The program instructions may be in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a communication network with user access via a plurality of data processor controlled interactive receiving display terminals, an electronic mail distribution system for permitting the sender of electronic mail (E-mail) to control the redistribution of sent E-mail messages comprising:
means enabling the sender of E-mail to specify conditions for the redistribution of an E-mail message sent to a receiving display terminal;
means enabling said sender to track the redistribution of said sent E-mail message; and
means enabling said sender to change said redistribution of said E-mail message.

2. The electronic mail distribution system of claim 1 further including means enabling a user at the terminal receiving said sent E-mail message to redistribute said sent E-mail message subject to said specified conditions.

3. The electronic mail distribution system of claim 2 wherein:
said sent E-mail message specifies tasks divided out of the sent E-mail message to be assigned respectively to subsequent receivers of said redistribution messages; and
further including delegation means at the terminal receiving said sent E-mail message enabling said user to delegate said tasks among said subsequent receivers of said redistribution messages.

4. The electronic mail distribution system of claim 3 further including means enabling said sender to send said E-mail for redistribution directly to said delegation means.

5. The electronic mail distribution system of claim 3 wherein said means enabling said sender to change said redistribution of said sent E-mail message enables the sender to cancel said sent E-mail message.

6. The electronic mail distribution system of claim 3 wherein said means enabling said sender to change said redistribution of said sent E-mail message enables the sender to cancel tasks delegated to subsequent receivers of said redistribution messages.

7. The electronic mail distribution system of claim 3 wherein said means enabling said sender to change said redistribution of said sent E-mail message enables the sender to preclude subsequent redistribution of said sent E-mail.

8. In a communication network with user access via a plurality of data processor controlled interactive receiving display terminals, an electronic mail distribution method for permitting the sender of E-mail to control the redistribution of sent E-mail messages comprising:
enabling the sender of E-mail to specify conditions for the redistribution of an E-mail message sent to a receiving display terminal;
enabling said sender to track the redistribution of said sent E-mail message; and
enabling said sender to change said redistribution of said E-mail message.

9. The electronic mail distribution method of claim 8 further including the step of enabling a user at the terminal receiving said sent E-mail message to redistribute said sent E-mail message subject to said specified conditions.

10. The electronic mail distribution method of claim 9 wherein:
said sent E-mail message specifies tasks divided out of the sent E-mail message to be assigned respectively to subsequent receivers of said redistribution messages; and
further including the step of enabling said user at said receiving terminal to delegate said tasks among said subsequent receivers of said redistribution messages.

11. The electronic mail distribution method of claim 10 further including the enabling of said sender to send said E-mail for redistribution directly to said delegation means.

12. The electronic mail distribution method of claim 10 wherein said step of enabling said sender to change said redistribution of said sent E-mail message enables the sender to cancel said sent E-mail message.

13. The electronic mail distribution method of claim 10 wherein said step of enabling said sender to change said redistribution of said sent E-mail message enables the sender to cancel tasks delegated to subsequent receivers of said redistribution messages.

14. The electronic mail distribution method of claim 10 wherein said step of enabling said sender to change said redistribution of said sent E-mail message enables the sender to preclude subsequent redistribution of said sent E-mail.

15. A computer program having code recorded on a computer readable medium for permitting the sender of E-mail to control the redistribution of sent E-mail messages in a communication network with user access via a plurality of data processor controlled interactive receiving display terminals comprising:
means enabling the sender of E-mail to specify conditions for the redistribution of an E-mail message sent to a receiving display terminal;
means enabling said sender to track the redistribution of said sent E-mail message; and
means enabling said sender to change said redistribution of said E-mail message.

16. The computer program of claim 15 further including means enabling a user at the terminal receiving said sent E-mail message to redistribute said sent E-mail message subject to said specified conditions.

17. The computer program of claim 16 wherein:
said sent E-mail message specifies tasks divided out of the sent E-mail message to be assigned respectively to subsequent receivers of said redistribution messages; and
further including delegation means at the terminal receiving said sent E-mail message enabling said user to delegate said tasks among said subsequent receivers of said redistribution messages.

18. The computer program of claim 17 further including means enabling said sender to send said E-mail for redistribution directly to said delegation means.

19. The computer program of claim 17 wherein said means enabling said sender to change said redistribution of said sent E-mail message enables the sender to cancel said sent E-mail message.

20. The computer program of claim 17 wherein said means enabling said sender to change said redistribution of said sent E-mail message enables the sender to cancel tasks delegated to subsequent receivers of said redistribution messages.

21. The computer program of claim 17 wherein said means enabling said sender to change said redistribution of said sent E-mail message enables the sender to preclude subsequent redistribution of said sent E-mail.
